(19) United States
(12) Patent Application Publication
(10) Pub. No.: US 2025/0131415 A1
(43) Pub. Date: Apr. 24, 2025

(54) Blockchain-Authenticated Communication Subscription System

(71) Applicant: Peter Bowers, Northridge, CA (US)

(72) Inventor: Peter Bowers, Northridge, CA (US)

(21) Appl. No.: 18/922,375

(22) Filed: Oct. 21, 2024

Related U.S. Application Data
(60) Provisional application No. 63/591,747, filed on Oct. 19, 2023.

(51) Int. Cl. G06Q 20/36; G06Q 20/38

(52) U.S. Cl. CPC G06Q 20/3674; G06Q 20/389

(57) ABSTRACT

A blockchain-authenticated communication subscription system that leverages smart contracts and non-fungible tokens to verify the ownership and authenticity of communication channels. The platform allows creators—individuals or organizations—to authenticate their identity by proving ownership of a smart contract or non-fungible token through cryptographic wallet signatures. Subscribers can opt into these subscription services and receive communications exclusively from verified creators, enhancing trust and reducing unsolicited messages. The system supports both cryptographic wallet-based and traditional authentication methods for subscribers. Communications can be delivered through secure channels and may be stored on-chain or referenced on-chain linking to off-chain data, ensuring transparency and immutability. The platform can be implemented using centralized, decentralized, or hybrid infrastructure to manage subscription data while maintaining authentication integrity. This invention provides an effective solution to unsolicited communications by verifying message origins through blockchain technology, minimizing reliance on traditional spam filters, and delivering a secure and trusted communication experience.

### CROSS-REFERENCE TO RELATED APPLICATIONS

This application claims the benefit of priority to U.S. Provisional Patent Application No. 63/591,747, filed on Oct. 19, 2023, titled “Blockchain-Authenticated Communication Subscription System,” the entirety of which is incorporated by reference herein.

### BACKGROUND OF THE INVENTION

In today's digital landscape, users are inundated with unsolicited communications from various sources, including promotional emails, phishing attempts, and spam messages. These unsolicited communications not only clutter user inboxes but also pose significant security risks. Malicious actors often exploit traditional communication channels to impersonate legitimate entities, leading to phishing attacks where sensitive information like passwords and financial details can be compromised.

Existing communication platforms, such as email and messaging applications, operate on models where anyone with access to a user's contact information can initiate communication without prior consent. While spam filters and security protocols attempt to mitigate unwanted messages, they are not foolproof. Sophisticated attacks frequently bypass these defenses, allowing malicious or unsolicited messages to reach users. Additionally, these platforms lack robust mechanisms to verify the authenticity of message senders, making it difficult for users to distinguish between legitimate communications and fraudulent ones.

Blockchain technology offers potential solutions to these challenges through its inherent features of transparency, immutability, and decentralization. Specifically, blockchain-based smart contracts, tokens, and cryptographic wallets provide a means for secure authentication and verification of ownership. A smart contract is a self-executing contract with the terms of the agreement directly written into code on the blockchain. A token is a digital asset created on a blockchain that can represent ownership rights, access privileges, or other forms of value. Tokens may be fungible, meaning they are interchangeable and identical in value (like cryptocurrency), or non-fungible, meaning they are unique and cannot be replaced by another identical item (like a digital collectible or proof of ownership for a specific asset). Ownership of a smart contract or token can be publicly verified on the blockchain, enabling entities to prove their identity and authenticity without relying on centralized authorities.

Despite the capabilities of blockchain technology, as of the filing of this application, there is a lack of systems that leverage smart contract ownership verification to authenticate creators in communication platforms. Existing blockchain-based platforms may authenticate subscribers by requiring them to hold specific tokens, but they do not provide mechanisms for subscribers to verify the authenticity or ownership of the communication source. This gap leaves users vulnerable to impersonation and phishing attacks, even within blockchain-enabled environments.

There is a need for a communication subscription system that leverages blockchain technology to authenticate creators by verifying their ownership of smart contracts or tokens. Such a system would enable subscribers to confidently receive communications from verified sources, reducing the risk of unsolicited messages and security threats.

### BRIEF SUMMARY OF THE INVENTION

The present invention provides a blockchain-authenticated communication subscription system. By allowing creators to prove their identity through verifying ownership of a smart contract or token using cryptographic authentication, the system ensures that subscribers receive communications exclusively from legitimate sources. This approach leverages blockchain technology to enhance security and trust in communication platforms, offering a practical and effective means to mitigate the risks associated with traditional communication systems and reduce unsolicited communications.

In this system, a creator-defined as an individual or organization-authenticates themselves by proving ownership of a smart contract or non-fungible token on a blockchain network. This is achieved by the creator signing a cryptographic message with their cryptographic wallet, which securely holds the private keys associated with their blockchain assets. The platform verifies this signature against the blockchain's public records to confirm ownership without exposing the creator's private key.

Once authenticated, the creator can establish a subscription service linked to the verified smart contract or non-fungible token. Subscribers can then opt into this subscription service, associating their subscription with the verified smart contract or token. This association ensures that the communication channel is trusted, as it is anchored to the immutable and transparent records of the blockchain.

The platform manages the delivery of communications from the creator to subscribers, ensuring that messages originate exclusively from the authenticated creator. Subscribers may authenticate their access to subscription services through either cryptographic wallets or traditional login methods, such as username and password, offering both security and accessibility.

The system reduces the risk of spam and phishing attacks by preventing unauthorized parties from impersonating creators. Since only creators who have verified ownership of the relevant smart contract or token can send communications through the platform, subscribers can trust the authenticity of the messages they receive.

The platform can be implemented using centralized servers, decentralized infrastructure, or a combination thereof, to manage subscription data and communications efficiently while maintaining the integrity of blockchain-based authentication. Communications from the creator to subscribers can be delivered through secure channels, including, but not limited to, in-platform messaging, email notifications, push notifications, SMS messages, webhooks, or any other secure communication methods.

Alternative embodiments of the system may include additional features, such as requiring subscribers to hold a specific token, being either fungible or non-fungible, as proof of membership or access rights. In some implementations, communications may be stored on the blockchain network, either entirely as on-chain data or as cryptographic references linking to off-chain data, ensuring immutability and transparency.

By leveraging the inherent security and transparency of blockchain technology, the present invention provides a novel solution to the challenges of unsolicited communications and sender authentication. It offers a secure, user-friendly platform that enhances trust between creators and subscribers, reduces the prevalence of spam, and improves the overall communication experience in digital environments.

### BRIEF DESCRIPTION OF DRAWINGS

FIG. 1 illustrates a flowchart depicting the process of creator authentication and subscription service initiation within the communication subscription system. The flowchart includes numbered steps, starting with step [101], where the creator initiates the process, and continuing through steps for cryptographic wallet connection, smart contract or token verification, subscription service registration, and authenticated communication between the creator and subscribers.

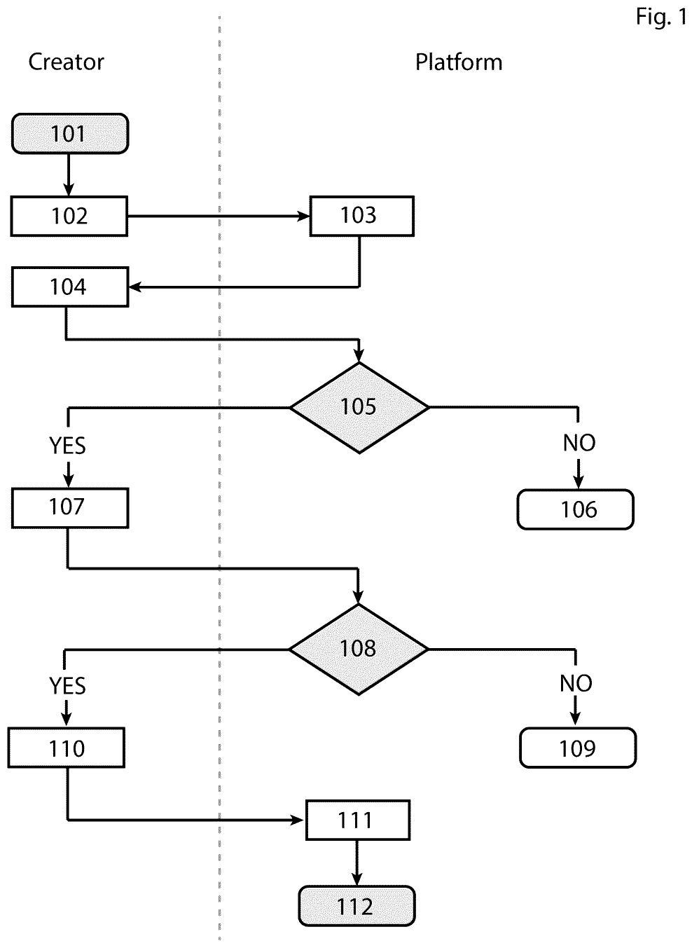

### DETAILED DESCRIPTION OF THE INVENTION

The present invention relates to a blockchain-authenticated communication subscription System that leverages blockchain technology, smart contracts, and cryptographic wallets to provide a secure and authenticated communication channel between Creators and Subscribers. This System addresses the issue of unsolicited communications by ensuring that only authenticated Creators can send messages to Subscribers who have explicitly subscribed to their services.

### System Overview

The System involves three primary entities: the Creator, the Subscriber, and the Platform.
System: The blockchain-authenticated communication subscription system that enables secure and authenticated communication between Creators and Subscribers as described herein.
Creator: An individual or organization that owns a smart contract or token and wishes to establish a subscription service to communicate with Subscribers.
Subscriber: An individual or entity that subscribes to a Creator's subscription service to receive authenticated communications.
Platform: A component of the System that facilitates the creation and management of subscription services, authenticates Creators and Subscribers, and enables secure communication between them.

By utilizing blockchain technology, specifically smart contracts and cryptographic wallets, the System authenticates Subscribers and manages subscriptions. It supports Web3 authentication methods to interface with Subscribers' wallets, offering an alternative to traditional username-password systems through cryptographic signatures. Web3 refers to a decentralized internet model that uses blockchain technology and smart contracts to enable peer-to-peer interactions, removing reliance on centralized servers or intermediaries.

### Components and Functionality

### Creator Authentication and Subscription Service Creation

To initiate the creation of a subscription service, the Creator accesses the Platform through a user interface [101], which may be available as a web-based application, mobile app, or decentralized application supporting Web3 interactions. The Creator connects to the platform via their cryptographic wallet—such as MetaMask, Ledger, or Trust Wallet—to begin the authentication process [102].

The Platform generates a unique, random message known as a nonce [103], serving as a cryptographic challenge to verify ownership of the wallet without revealing the private key. The Creator signs this nonce using their wallet's private key [104], a process facilitated by the wallet interface to ensure the private key remains secure and is not exposed to the Platform. The Platform then verifies the signed message by comparing it against the Creator's public wallet address [105]; successful verification confirms that the Creator controls the wallet associated with that address. A failed verification results in the end of the process [106].

After authentication, the Creator inputs the blockchain address of a smart contract or non-fungible token they claim to own [107]. The Platform queries the blockchain to retrieve ownership information of the provided smart contract or non-fungible token address [108]. The Platform compares the owner address obtained from the blockchain with the Creator's authenticated wallet address; if the addresses match, ownership is confirmed. Upon successful ownership verification, the Platform allows the Creator to proceed with creating the subscription service. A failed authentication results in the end of the process [109].

The Creator then may configure the subscription service by providing necessary details such as the service name and description [110]. They can set preferences for how communications will be delivered, including options like in-platform messaging or email notifications. The Platform registers the subscription service [111], associating it with the Creator's authenticated wallet and the verified smart contract or token. The subscription service is now available to Subscribers [112].

### Subscriber Authentication and Subscription Process

Subscribers access the platform to browse available subscription services, with options to search and filter to find services of interest. They may authenticate themselves by connecting their cryptographic wallets to the platform, establishing their identity without requiring personal information. Alternatively, Subscribers can use traditional authentication methods, such as username/email and password, to access the Platform.

Upon selecting a subscription service to join, the Subscriber may confirm the subscription and agree to any terms or conditions set by the Creator. The subscription is recorded by associating the Subscriber's identification—such as wallet address or user account—with the subscription service. In some embodiments, this recording is performed on a smart contract or decentralized ledger to ensure that the subscription status is transparent and tamper-proof.

### Secure Communication Management

The Creator composes messages or content intended for Subscribers, which can be created using the Platform's interface or generated externally and imported into the Platform. Optionally, messages may be signed by the Creator's private key to confirm authenticity before dispatch. The Platform queues the message for delivery to all Subscribers associated with the subscription service.

Messages are delivered to Subscribers through secure channels, such as encrypted in-Platform messaging systems or email notifications. The Platform verifies that each recipient is an active Subscriber to the service before delivering the message. Subscribers can configure their preferred channels for receiving notifications in their Platform settings.

Subscribers access messages through the Platform's interface or receive them directly via their chosen communication channel. Depending on the Creator's settings, Subscribers may be able to respond to messages or engage in two-way communication.

### Unsubscription and Subscription Management

Subscribers can unsubscribe from a service at any time through the Platform's interface. The Platform may prompt the Subscriber to confirm the unsubscription action to prevent accidental removals. Upon unsubscription, the Platform updates subscription records, removing the Subscriber's association with the service. Once unsubscribed, the Subscriber no longer receives communications from the Creator's subscription service.

Creators can, if the System is configured as such, view aggregate data about their Subscriber base, such as total Subscriber count, without accessing individual Subscriber identities. Subscribers can manage all their active subscriptions, including adjusting preferences or re-subscribing to services.

### Alternative Embodiments

In an alternative embodiment, access to the subscription service requires Subscribers to hold a specific token, serving as proof of membership or access rights. This token may be fungible or non-fungible. The Platform verifies token holdings in Subscribers' wallets before granting access to communications.

The System can also be adapted to work with smart contract wallets that allow for more complex authorization schemes and multi-signature approvals.

Additionally, the System can be integrated with existing communication platforms, such as email clients or messaging apps, through APIs or browser extensions, allowing Subscribers to receive authenticated communications within familiar interfaces.

### Use Case Scenarios

The invention can be applied in various scenarios. For instance, a company may establish a secure communication channel with its customers to send updates and important notifications. By creating a subscription service on the Platform, the company ensures that only authenticated messages reach Subscribers, enhancing trust.

Content creators and artists can release exclusive content to fans who subscribe to their service. Fans are assured that the content is authentic and directly from the artist, protected from counterfeit distributions.

Charitable organizations can communicate with donors and volunteers through the Platform, ensuring that appeals and updates are genuine, thus reducing susceptibility to fraud and phishing attempts.

### Technical Advantages

The System enhances security by leveraging cryptographic authentication, reducing the risk of impersonation and unauthorized communications. It respects user privacy by minimizing data collection and using wallet addresses for authentication without requiring additional personal information. Blockchain technology ensures that all transactions are transparently recorded and cannot be altered, providing an immutable audit trail.

### Implementation Considerations

To improve scalability and reduce transaction costs, the Platform can integrate Layer 2 technologies such as state channels or sidechains. The Platform can support multiple blockchain networks to cater to a wider user base. Implementing cross-chain bridges allows for interoperability between different blockchain ecosystems.

The Platform can provide intuitive guidance for users unfamiliar with blockchain technology, including tutorials and support resources. Support for multiple languages enhances accessibility for a global audience. The Platform can be optimized for mobile devices and to support mobile wallets for seamless interaction.

### CONCLUSION

The blockchain-authenticated communication subscription System offers a solution to unsolicited communications and sender authentication challenges. By leveraging blockchain technology for smart contract ownership verification, the Platform ensures that only authenticated Creators can engage with Subscribers. This System combines blockchain-based authentication with practical infrastructure, offering secure and user-friendly communication channels. Subscribers benefit from trusted interactions with verified Creators, reducing spam and enhancing the overall communication experience.

1. An authenticated communication subscription system, comprising:
a platform configured to:
allow a creator, defined as an individual or organization, to authenticate themselves by verifying ownership of a smart contract or non-fungible token on a blockchain network through signing a cryptographic message with a cryptographic wallet;
enable the creator to create a subscription service linked to the verified smart contract or token;
permit subscribers to opt into the subscription service, associating their subscription with the verified smart contract or token;
manage the delivery of communications from the creator to subscribers, ensuring that communications received by subscribers originate exclusively from the creator verified by the smart contract or non-fungible token;
wherein the platform uses blockchain-based smart contract or non-fungible token ownership verification for creator authentication, providing a secure communication channel that reduces unsolicited messages and spam.

2. The system of claim 1, wherein the platform verifies ownership by requiring the creator to sign a cryptographic message using a private key from their cryptographic wallet, ensuring secure authentication without exposing the private key.

3. The system of claim 1, wherein subscribers may authenticate their access to subscription services through either cryptographic wallets or traditional login methods, such as username and password.

4. The system of claim 1, wherein the platform provides subscribers with options to manage their subscriptions and communication preferences through a user interface.

5. The system of claim 1, wherein the verification of the creator's ownership of the smart contract or non-fungible token is performed during the creation of the subscription service and does not require repeated verification for each communication.

6. The system of claim 1, wherein the platform requires the creator to re-verify ownership of the smart contract or non-fungible token before each communication sent to subscribers.

7. The system of claim 1, wherein the creator composes messages using the platform's interface or imports messages generated externally into the platform for authentication and delivery to subscribers.

8. The system of claim 1, wherein the platform delivers communications from the creator to subscribers through secure channels, such as in-platform messaging or email notifications.

9. The system of claim 1, wherein the platform delivers communications from the creator to subscribers through various messaging mechanisms, including:
in-platform messaging within the platform interface;
push notifications on mobile or desktop devices;
email notifications sent to subscriber email addresses;
webhooks or API-based triggers for integration with external messaging services.

10. The system of claim 1, wherein the platform can be implemented using centralized servers, decentralized infrastructure, or a combination thereof, to manage subscription data and communications.

11. The system of claim 1, wherein communications from the creator to subscribers are stored on the blockchain network, either entirely as on-chain data or as cryptographic references stored on-chain linking to off-chain data, ensuring immutability and transparency.

12. The system of claim 1, wherein, in an alternative embodiment, access to the subscription service requires subscribers to hold a specific blockchain-based token issued by the creator, serving as proof of membership or access rights.

13. The system of claim 1, wherein, in an alternative embodiment, the platform implements enhanced security measures, including multi-factor authentication, to strengthen the authentication process for creators and subscribers.

14. A method for providing authenticated communication subscriptions, comprising:
verifying, by a platform, ownership of a smart contract or non-fungible token by a creator using a cryptographic wallet associated with a blockchain network;
enabling the creator to create a subscription service linked to the verified smart contract or non-fungible token;
allowing subscribers to subscribe to the subscription service, wherein the subscription is associated with the verified smart contract or non-fungible token;
facilitating the delivery of communications from the creator to the subscribers, ensuring that communications received by subscribers originate exclusively from the creator verified by the smart contract or non-fungible token.

15. The method of claim 14, wherein the verification of the creator's ownership of the smart contract or non-fungible token is performed during the creation of the subscription service and does not require repeated verification for each communication.

16. The method of claim 14, wherein the creator is required to verify ownership of the smart contract or non-fungible token prior to each communication sent to subscribers.

17. The method of claim 14, further comprising:
prompting the creator to sign a cryptographic message using their private key within the cryptographic wallet environment to verify ownership of the smart contract or non-fungible token during the creation of the subscription service.

18. The method of claim 14, wherein the creator composes messages using the platform's interface or imports messages generated externally into the platform for authentication and delivery to subscribers.

19. The method of claim 14, wherein subscribers authenticate their subscription access by connecting their cryptographic wallets to the platform, without requiring personal information for the authentication process.

20. The method of claim 14, wherein the platform delivers communications from the creator to subscribers through secure channels, such as in-platform messaging or email notifications.

21. The method of claim 14, wherein the platform can be implemented using centralized servers, decentralized infrastructure, or a combination thereof, to manage subscription data and communications.

22. The method of claim 14, further comprising storing communications on the blockchain network, either entirely as on-chain data or as cryptographic references stored on-chain that link to off-chain data, ensuring immutability and transparency.
